(19) United States
(12) Patent Application Publication
(10) Pub. No.: US 2012/0259661 A1
(43) Pub. Date: Oct. 11, 2012

(54) Systems and methods for data mining of DICOM structured reports

(75) Inventors: Craig A. Walker, Greenville, SC (US); Michal Kostrzewa, Warsaw (PL)

(73) Assignee: VidiStar, LLC, Greenville, SC (US)

(21) Appl. No.: 13/507,195

(22) Filed: Jun. 11, 2012

Related U.S. Application Data
(63) Continuation-in-part of application No. 12/932,973, filed on Mar. 10, 2011, now Pat. No. 8,200,505.

(51) Int. Cl. G06Q 50/24

(52) U.S. Cl. 705/3

(57) ABSTRACT

Systems and methods for extracting information from DICOM structured reports and similar types of input files include receiving at least one DICOM structured report and at least one criterion, applying the one or more criteria to each DICOM structured report to obtain result data, and generating a result for storage or display. Result information can further be queried for indexing and aggregation purposes, and the query results can be stored for searching, access, and report generation.

### CROSS REFERENCE TO RELATED APPLICATIONS

The present application is a continuation-in-part application which claims priority to and the benefit of the co-pending U.S. patent application having the Ser. No. 12/932,973, filed Mar. 10, 2011, which in turn claims priority to and the benefit of the U.S. patent application having the Ser. No. 11/592,608, filed Nov. 3, 2006. Application Ser. Nos. 12/932,973 and 11/592,608 are incorporated by reference herein, in their entirety.

### FIELD OF THE INVENTION

Embodiments usable within the scope of the present disclosure relate, generally, to methods and systems for extracting information from structured clinical reports, such as DICOM Structured Reports (DSR), to allow users, such as healthcare providers, researchers, healthcare facilities, patients, pharmaceutical companies, and other software engines, to access DSRs, and more specifically, to methods and systems usable to apply criteria and queries to DSRs to obtain results responsive to queries on a discrete basis, such as when requested by a user, and/or automatically, through periodic and/or continuous processes that index and/or aggregate information from DSRs for future access.

### BACKGROUND OF THE INVENTION

In the 1990s, the Digital Imaging and Communications in Medicine (DICOM) standards were published by the American College of Radiology and the National Electronic Manufacturers Association to outline a desired data format, flow, and hierarchy of electronic information in diagnostic images, to facilitate the transfer of such information between computer systems. With this advent, various healthcare professionals and facilities began to adopt standardized clinical reports that outline certain medical information in a uniform manner to facilitate interpretation and analysis.

However, the large majority of existing medical devices provide output data in various proprietary, unstructured formats, that vary depending on the type of device, the manufacturer thereof, and sometimes, even between different device models from the same manufacturer. In many cases, these output files contain images, text, or combinations thereof, often having different fonts, formats, layouts, and other characteristics. As such, the large majority of this non-standardized data does not include machine-readable information.

Co-pending application Ser. No. 12/932,973, and application Ser. No. 11/592,608, incorporated by reference above, relate to methods and systems usable to extract usable data (e.g., measurement values) from this type of non-standardized data through the application of unique libraries, plug-ins, and/or other tools, tailored to each type of input file, enabling a standard DICOM structured report format to be autopopulated with values after determining an appropriate plug-in for use, performing value object extraction on an input file using the plug-in, which extracts not only measurement values but also the data structure of the input file, then applying a report transformation to the extracted data structure and values to form a structured report.

DSRs created through the image-to-DSR conversion process described in applications Ser. Nos. 12/932,973 and 11/592,608, DSRs subjected to other conversion processes, or DSRs created through use of conventional reporting engines, such as those used by physicians, can be used as a source of valuable information for data mining. There are many types of information that can be extracted from DSR data, such as:

Clinical information (e.g., up-to-date nuclear medicine, showing normal perfusion for studies meeting certain criteria, such as sex, reconstruction method, radionucleotide used, etc.; correlations between diseases and other factors, such as sex, age, pharmaceutical usage, time, or other findings; querying of studies by pathology; classifying cases for teaching and/or presentations);

Assisting users reading a study and/or preparing a report (e.g., computer-aided detection, computer-aided diagnosis, validation if certain fields, such as diagnosis, indication, referring physician, etc., are completed before a healthcare provider signs a report);

Information used for accreditation and quality assurance (e.g., monthly procedure volumes by physician, sonographer, and/or other professionals, timeliness between conducting a study and creating a final report, validation of indications, etc.).

Information found in DSRs can be of use to physicians, patients, pharmaceutical companies, and other users associated with the healthcare industry, and such information can further be stored, transmitted, and/or otherwise manipulated for use and/or processing by other software. However, a DSR cannot be queried for such information directly, because DSRs are simply files stored in a Picture Archiving and Communications System (PACS) or similar type of system and/or repository. There exists a significant gap between the data found within a DSR and data structures (e.g., relational database or data warehouse-type structures), usable by reporting tools and data-mining (e.g., On-Line Analytical Processing (OLAP)) tools.

A need exits for systems and methods able to extract information from a set of stored and/or acquired DICOM structured reports.

A need also exists for systems and methods able to index information obtained from stored and/or acquired DICOM structured reports, thereby providing a method for invoking efficient queries of extracted information.

A further need exists for systems and methods able to aggregate and report information available from a set of stored and/or acquired DICOM structured reports and/or a set of information previously extracted and/or indexed from DSRs.

Embodiments usable within the scope of the present disclosure meet these needs.

### SUMMARY OF THE INVENTION

Embodiments usable within the scope of the present disclosure include methods for extracting information from DICOM structured reports that include receiving at least one DICOM structured report having a plurality of input data, receiving at least one criterion corresponding to at least one item of input data, applying the one or more criteria to the one or more DICOM structured reports to obtain result data, and generating a result containing the result data for storage and/or display.

DICOM structured reports from which information is extracted can be received from an image-to-DICOM structured report conversion engine (such as those disclosed in applications Ser. Nos. 12/932,973 and 11/592,608), from a physician reporting engine or similar software, or combinations thereof. As such, in an embodiment, one or more DICOM structured reports can be generated by an image-to-DICOM structured report conversion engine using one or more software plug-ins that identify modality, vendor, DICOM tags, DICOM structured report data (e.g., partial, incomplete, and/or non-standard reports), DICOM data, images, or combinations thereof; identifying desirable data in an input file; using one or more plug-ins to extract a data structure from the input file; extracting segments of images or DICOM data from an input file; performing value object extraction on the segments; determining a structured report template and converting the value objects and data structure to a standard DICOM structured report format; determining at least one report transformation usable to produce a structured report from the standard DICOM structured report format; and creating a requested report type using one or more report transformations.

Independent of the sources of input DICOM structured reports, embodiments of the present method can automatically or manually apply existing criteria, as well as additional criteria, as they are received and/or created, to existing DICOM structured reports, and/or apply existing criteria to additional DICOM structured reports as they are received and/or created. For example, a criterion repository can be queried manually, automatically, periodically, and/or continuously, as desired, to determine whether additional criteria for application to one or more DICOM structure reports have been added, and/or whether existing criteria have been modified. The additional and/or modified criteria can then be applied to the DICOM structured reports. Alternatively or additionally, a PACS server or similar repository can be queried manually, automatically, periodically, and/or continuously, as desired, to determine whether additional DICOM structured reports have been added, and/or whether existing DICOM structured reports have been modified. The criteria can then be applied to the additional and/or modified DICOM structured reports to produce additional and/or modified result data.

Result data can be stored in a result database, and one or more queries can be received (e.g., from a user device), responsive to which the result database can be searched, and a result layout containing one or more items of result data can be displayed. In an embodiment, a layout format can be selected from a repository containing a plurality of layout formats, and/or a desired layout format can be edited, created, and/or modified by a user, and the responsive result data can be displayed in the selected layout format.

In a further embodiment, one or more queries can be stored in a query repository, and these stored queries can be manually, automatically, periodically, and/or continuously applied to data in the result database, such that query results (e.g., items of result data responsive to one or more queries, in one or more desired layout formats) are readily available (e.g., indexed and/or aggregated) for future access, searching, display, and/or report generation.

The specific algorithm by which one or more criteria are applied to one or more DICOM structured reports to extract result data may vary depending on the format and/or source of a specific DICOM structured report, and/or the type of criteria. For example, in an embodiment, each criterion can have a criterion definition derived therefrom that includes at least one DICOM structured report pattern, at least one structured report path, and/or at least one rule (e.g., a business rule). An input DSR can then be compared with the one or more DICOM structured report patterns of the criterion definition to determine if there is a match therebetween (e.g., whether a DSR has all of the same nodes and/or other data structure elements as a DSR pattern), though it is generally not possible to extract measurement values from a matching DSR without further processing. As such, a value can be extracted from one or more DSRs using at least one structured report path (e.g., a Boolean value for a simple criterion, or a comparison of multiple values with preset ranges for a more complex criterion) that corresponds to the DSR pattern. The facts determined through use of the DICOM structured report patterns and/or the structured report paths can then be processed using one or more rules (e.g., from a business rule engine), thereby obtaining result values suitable for display, reporting, storage, aggregation, and/or indexing.

In a preferred embodiment a DICOM structured report can be displayed on a user device using a graphical user interface, such that a user can simply select one or more concepts from a displayed report (e.g., by clicking on a concept and/or providing it with a label), and these user selections can be used to define the underlying criterion definition (e.g., by defining, modifying, and/or constructing a structured report path and/or a DSR pattern).

Embodiments of the above-described method can be performed using embodied systems which can include a server (e.g., a PACS server) in communication with a conversion engine, a reporting engine, or combinations thereof, the server having a plurality of DSRs stored thereon. A criteria processor, in communication with the server and a criteria repository, can apply a plurality of criteria to the plurality of DSRs to obtain result data, which can be stored in a result database. A query engine in communication with the result database can receive a query (e.g., from a user device and/or a query repository), apply the query to the result database to generate query results, and display and/or store the query results in a query result database. A criteria editor can be used to edit, add, and/or remove criteria from the criteria repository (which can include editing, adding, and/or removing DSR patterns, structured report paths, and/or rules). A query editor can be used to edit, add, and/or remove queries from a query repository for application to the result database. In an embodiment, a query result presenter can be provided in communication with the query engine and/or the query result database, and further in communication with a layout repository, for populating a selected layout with one or more results from the query result database. A layout editor can be provided for editing, adding, and/or removing layouts from the layout repository.

### BRIEF DESCRIPTION OF THE DRAWINGS

The accompanying drawings, which are incorporated in and constitute a part of the specification, illustrate a preferred embodiment of the invention and together with the general description of the invention given above and the detailed description of the preferred embodiment given below, serve to explain the principles of the invention.

FIG. 1 depicts a diagram of an embodiment of a system usable within the scope of the present disclosure.

FIG. 2 depicts a diagram of an embodiment of components used to define criteria for performing information extraction and indexing.

FIG. 3 depicts a flow diagram of an embodiment of an information extraction process usable within the scope of the present disclosure.

FIG. 4 depicts a flow diagram of an embodiment of an information indexing process usable within the scope of the present disclosure.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

Embodiments usable within the scope of the present disclosure relate to systems and methods for extracting information from DICOM structured reports. Information extraction can include simple responses to queries, or more complicated forms of analysis. For example, a simple query may include a question relating to a single DSR, such as “What is the LV volume seen in this study?” responsive to which embodiments of the present systems and methods can navigate through the DSR tree (e.g., the data structure relating to the given DSR), locate a node meting certain criteria (e.g., the node corresponding to the value for LV volume), and returning the measurement value for that note. A more complex query, such as “Is this study normal?” or “Does this study demonstrate disease X?” may require locating several measurement values, possibly from multiple DSRs, and comparing various findings with normal ranges and/or parameters, then producing a Boolean result. A “normal” criteria may differ from study to study, from query to query, and may also differ at each location (e.g., a clinic or hospital). As such, in an embodiment, a user of the present systems and methods can define normal criteria and/or parameters generally, and/or with each query. More generally, in an embodiment, a user can define a very particular query (e.g., the information the user desires to extract from a DSR instance), through use of versatile query language, which can vary from simple extraction queries (e.g., through use of DSR paths), through Boolean/algebraic expressions, and/or through procedural languages common to expert systems.

As such, embodiments usable within the scope of the present disclosure are usable with a single DICOM structured report; however, preferred embodiments are usable to extract and/or index information from many instances of DICOM structured reports, in such a way that this information is readily available for further queries (e.g., through use of SQL language). As described above, embodiments of the present systems and methods can accommodate the additional and/or modification of information extraction criteria and/or DICOM structured reports at any time, which can be processed, and the information extracted therefrom indexed on a continuous, periodic, and/or manual basis. As such, queried data extracted from a set of DICOM structured reports can be filtered, sorted, aggregated (e.g., grouped with other data, such as by calculation of statistical functions like count, average, standard deviation, etc.), and output reports can be provided in various output formats (e.g., HTML, PDF, XLS, CSV, TXT, etc.)

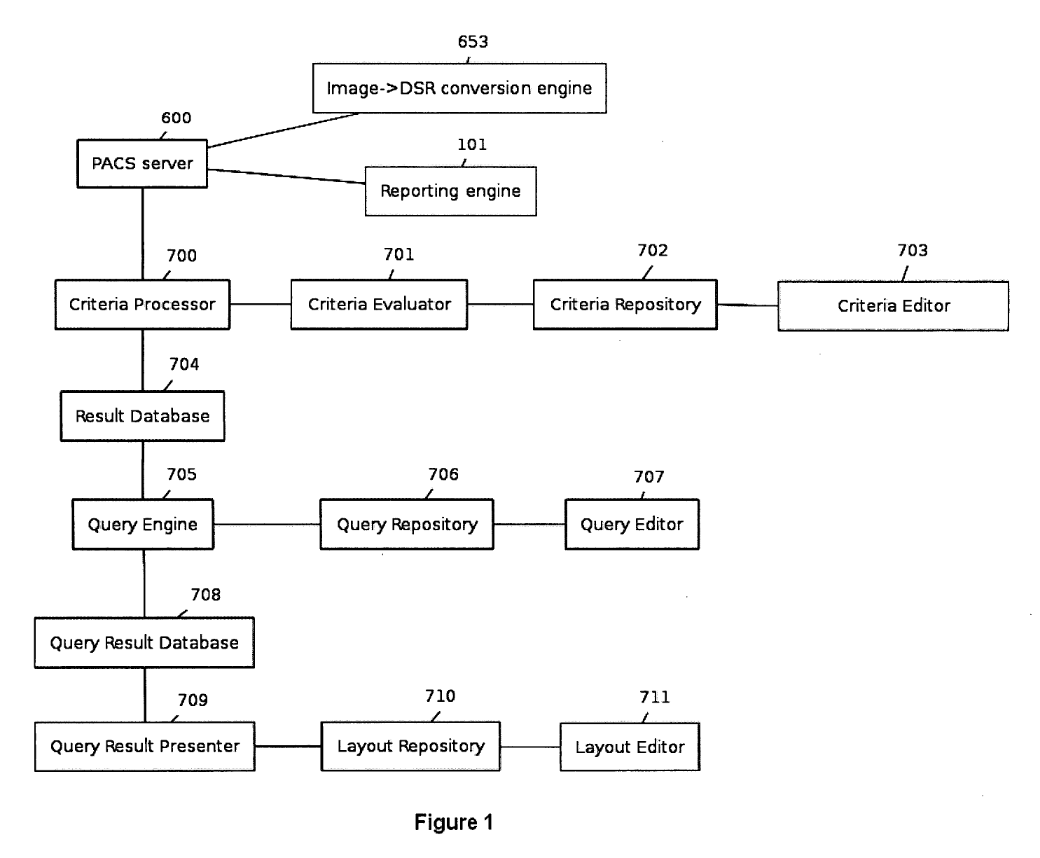

Referring now to FIG. 1, a diagram of an embodiment of a system usable within the scope of the present disclosure is shown. Specifically, FIG. 1 shows a PACS server (600), usable to store a set of DICOM structured reports obtained from various modalities, created manually or automatically by an Image-to-DSR conversion engine (653) (such as that disclosed in application Ser. Nos. 12/932,973 and 11/592,608), or created using a reporting engine (101) (e.g., by a human).

A criteria processor (700), in communication with the PACS server (600) is usable to index information by operating on DICOM structured reports obtained from the PACS server (600). Specifically, the criteria processor (700) is shown in communication with a criteria repository (702), which can include any manner of server or other data storage (including the PACS server (600)), and can include any number of criteria stored thereon. The criteria processor (700) invokes a criteria evaluator (701) to apply each criterion from the criteria repository (702) to each DICOM structured report from the PACS server (600), and stores the result information in a result database (704). The criteria evaluator (701) is responsible for extracting information from input DICOM structured reports based on the input criteria used. Specific exemplary processes relating to the application of the criteria and/or use of the criteria evaluator (701) are described above and below.

The criteria processor (700) can maintain the integrity of the result database (704) and ensure the information therein remains current by accounting for new criteria being introduced into the criteria repository (702) and/or new DICOM structured reports being stored in the PACS server (600). For example, if a new criterion is added to the criteria repository (702) and/or an existing criterion is modified, the criteria processor (700) can apply the new and/or modified criterion to all existing DICOM structured reports and store the result information in the result database (704). If a new DICOM structured report is stored in the PACS server (600) and/or an existing DICOM structured report is modified, the criteria processor (700) can apply all existing criteria from the criteria repository (702) to the new and/or modified DICOM structured report and store the result information in the result database (704). FIG. 1 further depicts a criteria editor (703) in communication with the criteria repository (702), which can be used to add, remove, and/or modify criteria.

A query engine (705), in communication with the result database (704), can be used to aggregate and/or report information from the result database (704). Specifically, results from the result database (704) can be queried (e.g., filtered, aggregated) through the application of queries (e.g., SQL queries) stored in an associated query repository (706), which can include any manner of server or other data storage (including the PACS server (600)). The resulting datasets can be stored in a query result database (708), for future access and/or reporting. In an embodiment, the query engine (705) can be used to account for the addition of new queries and/or the modification of existing queries, which can be subsequently applied (e.g., manually or automatically) to each item of result information in the result database (704) to form query results that can be stored in the query result database (708). A query editor (707) is shown in communication with the query repository (706), for use adding, removing, and/or modifying queries.

A query result presenter (709), in communication with the query result database (708), can be used to present information from the query result database (708), e.g., as a printed or displayed report. The result datasets in the query result database (708) are used as input datasets for reports presented by the query result presenter (709), which uses one or more layouts stored in a layout repository (710) to determine how to layout data on a page or screen. As such, the query result presenter (709) can analyze one or more result datasets from the query result database (708), then populate one or more automatically or manually selected layouts from the layout repository (710) with result information to form a report or other desired form of output. A layout editor (711) can be used to add, remove, and/or modify layouts in the layout repository (710).

It should be noted that FIG. 1 depicts a system usable as a complete framework for processing raw medical images and similar raw data to aggregated information suitable for access and reporting. Specifically, use of an image-to-DSR conversion engine (653), PACS server (600), criteria processor (700), criteria evaluator (701), result database (704), query engine (705), query result database (708), and query result presenter (709), along with appropriate repositories, can produce highly aggregated analytical from a series of non-standard input files (such as DICOM reports from various modalities). Such a framework can be applied in both commercial and scientific environments, as well as elsewhere.

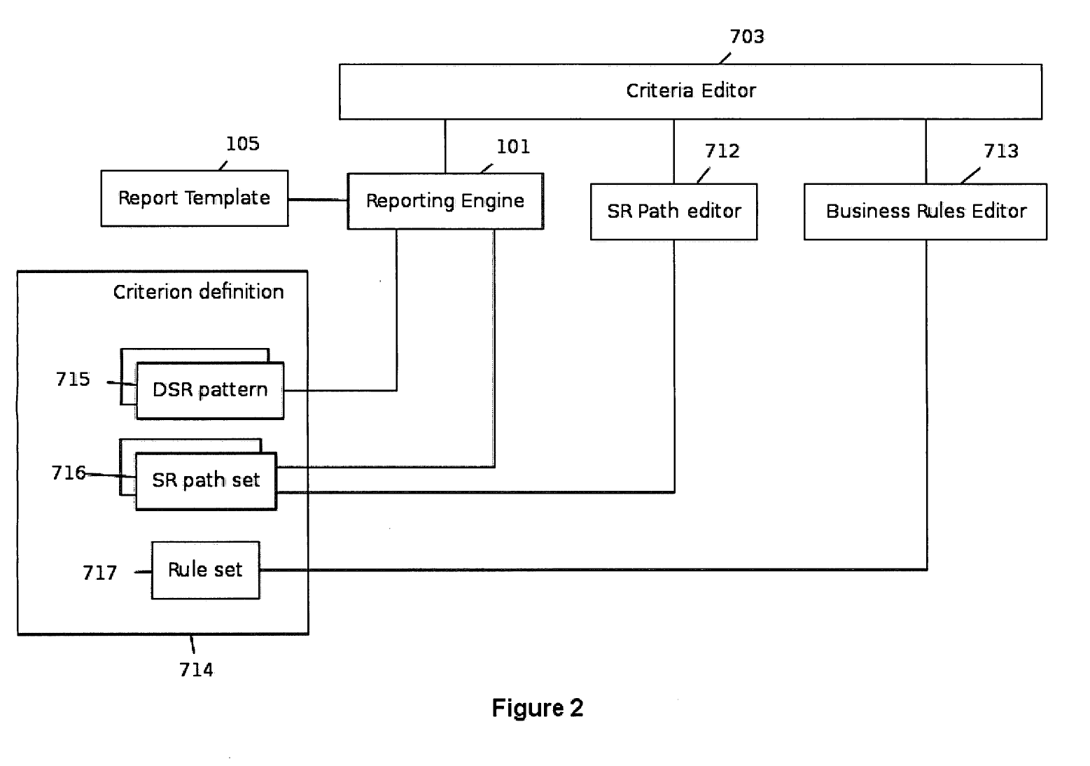

Referring now to FIG. 2, a diagram depicting an embodiment of components used to define criteria, used to enable the information extraction and indexing performed by the criteria evaluator (701, shown in FIG. 1) and criteria processor (700, shown in FIG. 1), is shown.

Each criterion in the criteria repository (702, shown in FIG. 1) includes an associated criterion definition (714), which determines how the specific criterion is applied (e.g., the type of DICOM structured report upon which the criterion would be effective, the type of information extracted and how the information is extracted, how such information is indexed and/or otherwise output.) The criterion definition (714) includes a rule set (717), which is a set of business rules, such as those found in business rules engines. The facts produced through the application of the rule set (717) are produced by processing structured report paths from a structured report path set (716) and/or comparing input DICOM structured reports to a set of DSR patterns (715). This process is explained in greater detail below.

The rule set (717) can be manipulated (e.g., rules can be added, removed, and/or modified) using a business rules editor (713), while both the structured report path set (716) and the set of DSR patterns (715) can be manipulated using the reporting engine (101). For example, using a graphical user interface provided to a user via a report editor window (e.g., when viewing a report template (105)), a user can flag, mark, and/or otherwise label elements of a displayed report that he or she desires to extract, and a corresponding structured report path set (716) can be generated responsive to a user's selections. Similarly, a set of selections (e.g., a DICOM structured report instance) can be created and stored as a DSR pattern in this manner. When using such an embodiment, a user can simply use the same graphical interface used for editing of a report, and need not be aware of the complexity of the DSR tree coding (e.g., the tree structure of a given template, coded terminology, etc.) A user can simply click on or otherwise select a concept from a report, and flag and/or otherwise label the concept. The DSR path behind the selected concept is then extracted from the report template (705) and stored into the structured report path set (716) of the criterion definition (714). In more complex cases, where no template with a graphical user interface exists, such as when a DICOM structured report is produced automatically using an image-to-DSR conversion engine, it is possible to edit a structured report path directly using a structured report path editor (712).

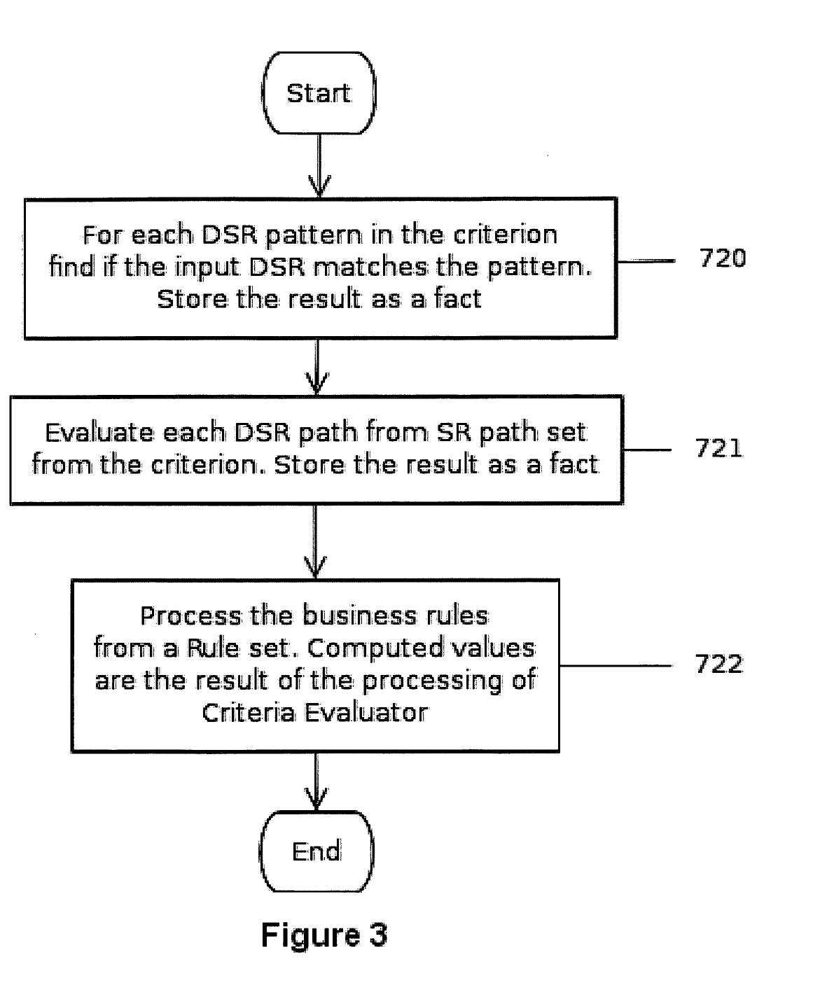

Referring now to FIG. 3, a flow diagram depicting an embodiment of an information extraction process performed by the criteria evaluator (701, shown in FIG. 1), using a criterion definition (714, shown in FIG. 2) and an incoming DICOM structured report as inputs, is shown. Steps (720) and (721) prepare facts for processing by the business rule engine in step (722). Specifically, in step (720), DICOM structured report patterns are processed—for each DSR pattern in a criterion definition, a determination is made whether the input DICOM structured report matches the pattern. This result is stored as a fact. DSR patterns can be a simple manner in which criteria are defined, via a “query-by-example” concept. An input DICOM structured report that has all nodes present in its report template will either match or fail to match a DSR pattern. However, it is not possible to extract measurement values from a report using this method alone. In step (721), SR path set processing is performed—for each structured report path in a criterion definition, a corresponding value is extracted from an input DICOM structured report and stored as a fact. The value may be a Boolean value (e.g., if a structured report path is simply a path to a code node having a fixed value) or the value may be a specific value (e.g., text, numeric, date, time—if the structured report path leads to a typed node). In step (722), the facts obtained in the previous steps (720, 721) are processed using the rule set of the criterion definition to obtain result values. These result values are the processing result of the criteria evaluator (701, shown in FIG. 1), and can subsequently be stored in the result database (704, shown in FIG. 1).

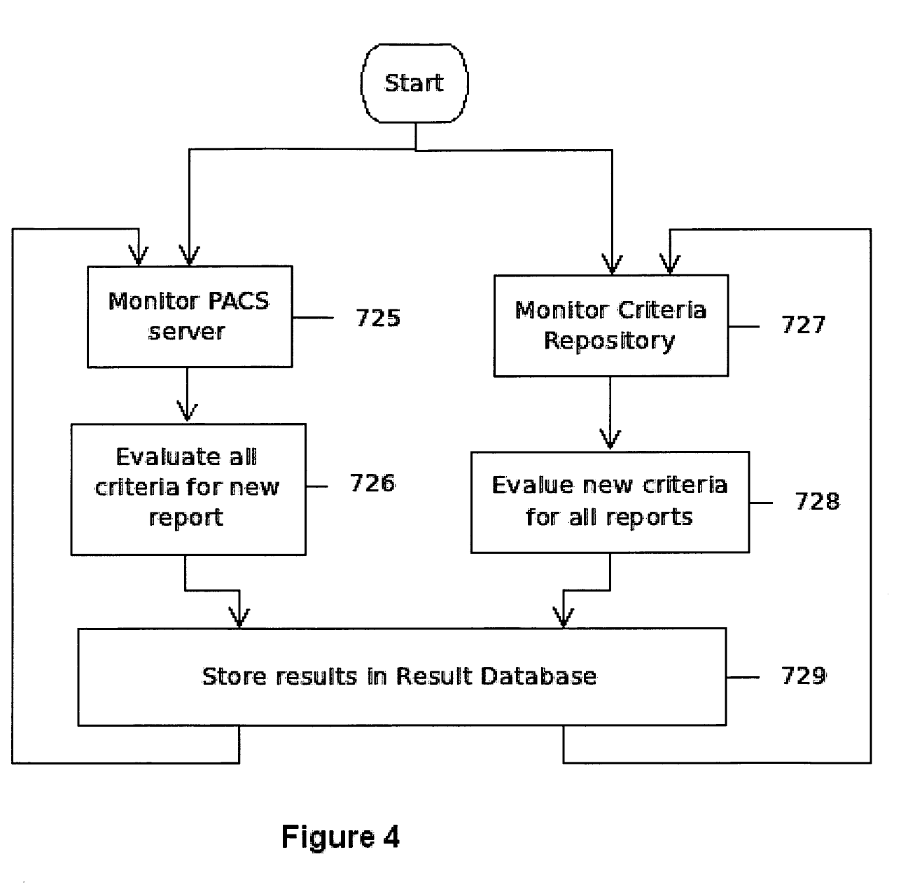

Referring now to FIG. 4, a flow diagram showing an embodiment of an information indexing process performed by the criteria processor (700, shown in FIG. 1), is depicted. The depicted process includes two sub-processes: monitoring the PACS server (600, shown in FIG. 1) for incoming (e.g., additional, removed, and/or modified) DSR files (steps (725) and (726)); and monitoring the criteria repository (702, shown in FIG. 1) for incoming (e.g., additional, removed, and/or modified) criteria (steps (727) and (728)). Specifically, in step (725), the PACS server is monitored for additional (or modified/removed) DICOM structured reports. Such monitoring can be performed automatically (e.g., on a continuous or periodic basis), or manually (e.g., on discrete instances initiated by a user). Further, in an embodiment such monitoring can be implemented with a “push” or “pull” approach—a push-type system can be implemented by causing the PACS server to notify the criteria processor regarding new (or removed/modified) DICOM structured reports (e.g., by invoking DICOM StoreSCP of the criteria processor); a pull-type system can be implemented by causing the criteria processor to periodically poll the PACS server for new (or modified/removed) DICOM structured reports (e.g., using DICOM QueryRetrieve SCP).

If a new DICOM structured report file is located in step (725), then in step (726), all of the criteria defined in the criteria repository are evaluated (with use of the criteria evaluator) and applied to any new report(s) located in the PACS server. In step (729), the result values, of various types (Boolean, numbers, text, etc.), can then be stored in the result database. This data can be marked with a criterion definition identifier, as well as a value identifier (local to the corresponding criterion definition.)

Similarly, in step (727), the criteria repository is monitored; specifically, the criteria processor can automatically or manually determine whether there are any new or modified/removed criteria definitions within the criteria repository (e.g., through a push or pull process). If new and/or modified criteria definitions are located, then in step (728), each new and/or modified criterion is used to process all existing DICOM structured report files. The results are stored in the result database (step (729)), and in an embodiment, can override previous results obtained for the same file and/or criterion definition, if any exist. This process ensures consistency between the criteria repository, PACS server, and result database. In a preferred embodiment, the result database can include a pure SQL database, to enable easy querying of the result database with existing tools or libraries.

Embodiments usable within the scope of the present disclosure thereby provide systems and methods usable to extract information from stored and/or acquired DICOM structured reports that would otherwise be accessible only in a visual format to users, index and aggregate such information, and enable querying and reporting of such information, while enabling users to navigate this information using simple graphical interfaces and database queries.

What is claimed is:

1. A method for extracting information from DICOM structured reports, the method comprising the steps of:
receiving at least one DICOM structured report comprising a plurality of input data;
receiving at least one criterion corresponding to at least one item of input data within said at least one DICOM structured report;
applying said at least one criterion to said at least one DICOM structured report to obtain result data from said at least one DICOM structured report, wherein the result data corresponds to said at least one item of input data; and
generating a result containing the result data for storage or display.

2. The method of claim 1, wherein the step of receiving said at least one DICOM structured report comprises establishing communication with an image-to-DICOM structured report conversion engine, a physician reporting engine, or combinations thereof.

3. The method of claim 2, wherein the step of receiving said at least one DICOM structured report comprises establishing communication with an image-to-DICOM structured report conversion engine, and wherein the image-to-DICOM structured report conversion engine generates said at least one DICOM structured report from at least one input file using a plurality of software plug-ins that identify a plurality of data comprising: modality; vendor; DICOM tags; DICOM structured report data comprising partial, incomplete, or non-standard reports; DICOM data; images; or combinations thereof, and wherein the image-to-DICOM structured report conversion engine performs data recognition on said at least one input file by:
determining whether the plurality of software plug-ins include at least one plug-in usable to perform value object extraction on said at least one input file;
identifying measurement data, report pages, images, DICOM Structured Report data, DICOM data, or combinations thereof, within said at least one input file;
using said at least one plug-in to extract a data structure from said at least one input file;
extracting segments of images, or DICOM data from said at least one input file;
performing value object extraction on the segments to form value objects;
determining a structured report template to be created and converting the value objects and the data structure to a standard DICOM Structured Report format;
searching a plurality of report transformations to determine at least one transformation usable to produce a structured report from the standard DICOM Structured Report format;
permitting selection of said at least one transformation by a user, thereby defining a requested report type; and
creating the requested report type from said at least one transformation, forming a report with autopopulated values.

4. The method of claim 1, further comprising the steps of receiving at least one additional criterion and applying said at least one additional criterion to said at least one DICOM structured report.

5. The method of claim 4, wherein the steps of receiving said at least one additional criterion and applying said at least one additional criterion comprise periodically querying a criterion repository to locate additional criteria for application to said at least one DICOM structured report.

6. The method of claim 4, wherein the steps of receiving said at least one additional criterion and applying said at least one additional criterion comprise receiving a notification indicating receipt of said at least one additional criterion and applying said at least one additional criterion to said at least one DICOM structured report responsive to the notification.

7. The method of claim 1, further comprising the steps of receiving at least one additional DICOM structured report and applying said at least one criterion to said at least one additional DICOM structured report.

8. The method of claim 7, wherein the steps of receiving said at least one additional DICOM structured report and applying said at least one criterion to said at least one additional DICOM structured report comprise periodically querying a server to locate additional DICOM structured reports for information extraction.

9. The method of claim 7, wherein the steps of receiving said at least one additional DICOM structured report and applying said at least one criterion to said at least one additional DICOM structured report comprise receiving a notification indicating receipt of said at least one additional DICOM structured report and applying said at least one criterion to said at least one additional DICOM structured report responsive to the notification.

10. The method of claim 1, further comprising the steps of storing the result data in a result database, receiving at least one query, searching the result database responsive to said at least one query to obtain items of result data responsive to said at least one query, and displaying a result layout containing the items of result data responsive to said at least one query.

11. The method of claim 10, wherein the step of displaying the result layout comprises receiving a layout format from a layout repository comprising a plurality of layout formats and displaying the result layout in a format defined by the layout format.

12. The method of claim 1, further comprising the steps of storing the result data in a result database, applying at least one query from a query repository to the result database to obtain items of result data responsive to said at least one query, storing the items of result data responsive to said at least one query in a query database, receiving a request to display at least one item of result data from the query database, and displaying said at least one item of result data from the query database responsive to the request.

13. The method of claim 1, wherein the step of applying said at least one criterion to said at least one DICOM structured report comprises:
deriving a criterion definition from said at least one criterion, wherein the criterion definition comprises at least one DICOM structured report pattern, at least one structured report path, and at least one rule;
determining whether said at least one DICOM structured report matches said at least one DICOM structured report pattern to form a first determination;
extracting a value from said at least one DICOM structured report using said at least one structured report path to form a second determination; and
processing the first determination and the second determination using said at least one rule to obtain the result data.

14. The method of claim 1, wherein the step of receiving said at least one criterion corresponding to said at least one item of input data comprises: displaying said at least one DICOM structured report on a user device using a graphical user interface, wherein said at least one DICOM structured report comprises a plurality of concepts; receiving a selection of at least one of said concepts from the user device; and defining said at least one criterion using the selection.

15. A system for extracting information from DICOM structured reports, the system comprising:
a server in communication with a conversion engine, a reporting engine, or combinations thereof, wherein the server comprises a plurality of DICOM structured reports stored thereon;
a criteria processor in communication with the server and a criteria repository having a plurality of criteria stored thereon, wherein the criteria processor comprises computer instructions for instructing the criteria processor to apply the plurality of criteria to the plurality of DICOM structured reports to obtain result data;
a result database in communication with the criteria processor for receiving and storing the result data; and
a query engine in communication with the result database, wherein the query engine comprises computer instructions for instructing the query engine to receive a query, apply the query to the result database to generate query results, and display the query results, store the query results in a query database, or combinations thereof.

16. The system of claim 15, further comprising a criteria editor in communication with the criteria processor and the criteria repository, wherein the criteria editor comprises computer instructions for instructing the criteria processor to generate at least one additional criterion, to modify at least one criterion of the plurality of criteria, or combinations thereof.

17. The system of claim 15, wherein each criterion of the plurality of criteria comprises a criterion definition derived from at least one structured report path, at least one DICOM structured report pattern, at least one rule, or combinations thereof.

18. The system of claim 15, further comprising a query result presenter in communication with the query engine, the query result database, or combinations thereof, and further in communication with a layout repository comprising at least one layout, wherein the query result presenter comprises computer instructions for instructing the query result presenter to populate a selected layout from the layout repository with at least one selected result from the query result database.
